(19) United States
(12) Patent Application Publication
(10) Pub. No.: US 2026/0004653 A1
(43) Pub. Date: Jan. 1, 2026

(54) INFORMATION PROCESSING DEVICE, INFORMATION PROCESSING METHOD, AND PROGRAM

(71) Applicant: NS Solutions Corporation, Minato-ku, Tokyo (JP)

(72) Inventors: Chizuru MORI, Minato-ku, Tokyo (JP); Kazuyoshi MORIYA, Minato-ku, Tokyo (JP)

(21) Appl. No.: 18/870,264

(22) PCT Filed: Jul. 13, 2023
(86) PCT No.: PCT/JP2023/025833

§ 371 Date: Sep. 11, 2025

(30) Foreign Application Priority Data
Oct. 4, 2022 (JP) 2022-160123

(51) Int. Cl. G08B 29/18; G06V 20/52; G06V 40/20; G08B 21/04

(52) U.S. Cl. CPC G08B 29/185; G08B 21/0423; G06V 20/52; G06V 40/23

(57) ABSTRACT

An object is to contribute to improvement in accuracy of detection for an abnormal situation.

An identification unit configured to identify a movement type of a user, and a detection unit configured to detect an abnormal situation of the user using a determination criterion based on the movement type identified by the identification unit via a sensor provided to the user or provided in periphery of the user are provided.

### TECHNICAL FIELD

The present invention relates to an information processing device, and information processing method, and a program.

### BACKGROUND ART

Recent advancement in automation and labor saving for work in factories, agricultural work places, and the like has made it possible to accomplish work with smaller manpower. On the other hand, the smaller manpower leads to a higher risk of an abnormal situation of a worker such as tumbling (such as tumbling by tripping over something or due to his or her poor health condition) and falling being unnoticeable by other workers. The situation may be serious in cases such as that where the worker becomes unmovable or unconscious as a result of injury caused by the tumbling or falling in particular.

In order to avoid such a serious situation, a technique for detecting an abnormal situation such as tumbling using a sensor has been proposed. Patent Literature 1 discloses a technique in which an acceleration sensor is attached to a required position of a person and tumbling is detected when acceleration obtained from the sensor exceeds a reference acceleration set in advance.

### Citations List

### Patent Literature

Patent Literature 1: JP 2004-252618 A

### SUMMARY OF INVENTION

### Technical Problems

There has been a demand for improving the accuracy of detection for an abnormal situation. In view of this, the sensitivity of the sensor may be increased to detect the abnormal situation without fail. Still, excessive increase in the sensitivity leads to excessive detection. An abnormal situation likely to occur and an abnormal situation less likely to occur may differ among user situations. For example, a user is working at a flat low position is almost completely free of risk of falling. Thus, detection of falling in a situation where the user cannot fall leads to a higher possibility of erroneous detection. With the conventional technique, the accuracy of the detection for the abnormal situation is limited under such a situation.

The present invention is made in view of the problem described above, an object thereof is to contribute to improvement in the accuracy of the detection for the abnormal situation.

### Solutions to Problems

An information processing device of the present invention to achieve the object described above includes an identification unit configured to identify a movement type of a user, and a detection unit configured to detect an abnormal situation of the user using a determination criterion based on the movement type identified by the identification unit via a sensor provided to the user or provided in periphery of the user.

### Advantageous Effects of the Invention

The present invention can contribute to improvement in accuracy of detection for an abnormal situation.

### BRIEF DESCRIPTION OF DRAWINGS

FIG. 1 is a diagram illustrating an example of a system configuration of a detection system.

FIG. 2 is a diagram illustrating an example of a hardware configuration of a server device.

FIG. 3 is a diagram illustrating an example of a reference value table.

FIG. 4 is a diagram illustrating an example of a sensitivity table.

FIG. 5 is a diagram illustrating an example of a hardware configuration of a terminal device.

FIG. 6 is a diagram illustrating an example of a functional configuration of the server device.

FIG. 7 is a flowchart illustrating an example of detection processing.

FIG. 8 is a diagram illustrating an example of a sensitivity table.

FIG. 9 is a flowchart illustrating an example of detection processing.

FIG. 10 is a diagram illustrating an example of a sensitivity table.

FIG. 11 is a flowchart illustrating an example of detection processing.

FIG. 12 is a diagram illustrating an example of a reference value table.

FIG. 13 is a diagram illustrating an example of a sensitivity table.

FIG. 14 is a flowchart illustrating an example of detection processing.

### DESCRIPTION OF EMBODIMENTS

### First Embodiment

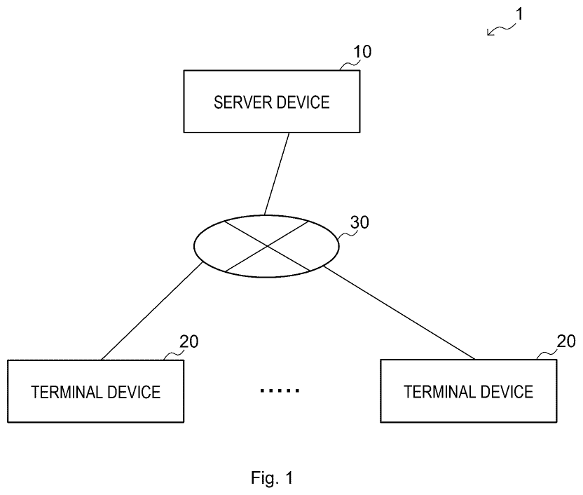

FIG. 1 is a diagram illustrating an example of a system configuration of a detection system 1 of the present embodiment. The detection system 1 is a system that detects an abnormal situation of a user, and includes a server device 10, and a terminal device 20 provided to each of one or more users that perform work such as agricultural work on a farm and work in a factory. The server device 10 and each terminal device 20 are connected to each other via a network 30.

The server device 10 is an information processing device such as a server computer or a general-purpose computer that detects an abnormal situation of the user, based on a signal acquired via various sensors. In the present embodiment, the server device 10 detects tumble, fall, impact, lying immobile, fatigue, and high heart rate as the abnormal situation. Tumble means falling down. Fall means falling from a high place. Impact means that acceleration of a certain level or more is applied. Lying immobile means falling down and not moving. Fatigue means that fatigue is accumulated. High heart rate means that the heart rate is higher than usual.

The terminal device 20 is an information processing device such as a smartphone or a smartwatch that includes a sensor and transmits a signal, acquired via the sensor, to the server device 10.

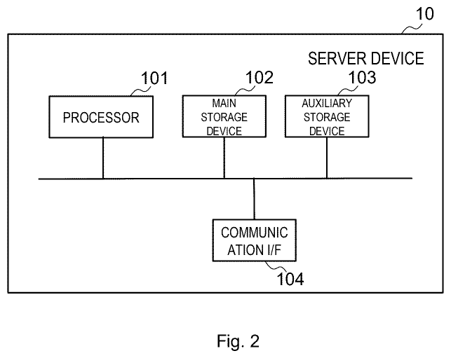

FIG. 2 is a diagram illustrating an example of a hardware configuration of the server device 10.

The server device 10 includes a processor 101, a main storage device 102, an auxiliary storage device 103, and a communication interface (I/F) 104.

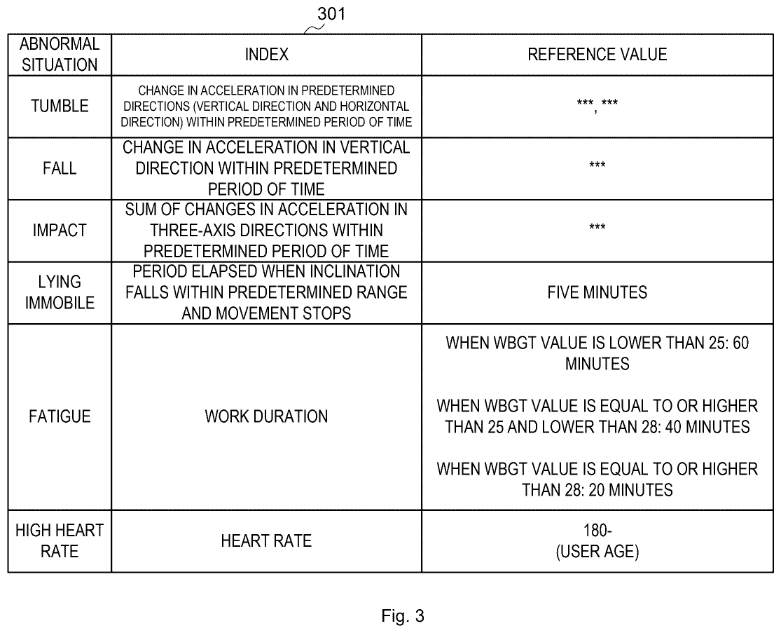

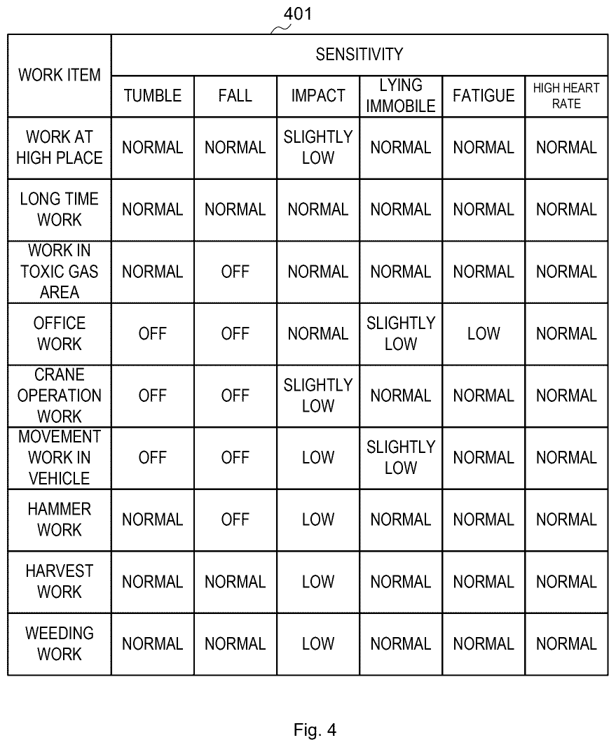

The processor 101 is a control device that controls the server device 10. The main storage device 102 is a storage device such as a random access memory (RAM) used for temporarily storing information, loading a program, and the like. The auxiliary storage device 103 is a storage device such as a hard disk drive (HDD) or a solid state drive (SSD) that stores various types of information such as a reference value table 301 described below with reference to FIG. 3 and a sensitivity table 401 described below with reference to FIG. 4, and various programs. The communication I/F 104 is an interface used for communication with an external device such as the terminal device 20 via the network 30.

The reference value table 301 will be described with reference to FIG. 3.

The reference value table 301 indicates correspondence between an abnormal situation and an index and a reference value used for determining the abnormal situation. The reference value is a value indicating the value of the index with which the corresponding abnormal situation can be determined to be occurring. In the present embodiment, the server device 10 detects an abnormal situation when the value of the index corresponding to the abnormal situation becomes equal to or more than the reference value.

The reference value table 301 includes items “abnormal situation” indicating an abnormal situation, as well as “index” and “reference value” indicating the index and the reference value used for determining the corresponding abnormal situation.

In the present embodiment, the reference value table 301 includes indices and reference values corresponding to respective abnormal situations including tumble, fall, impact, lying immobile, fatigue, and high heart rate.

In the present embodiment, the index used for detecting tumble is a variation value of the acceleration applied to the user in the vertical direction and the horizontal direction, for a predetermined period of time (such as a second or two seconds for example). The index used for detecting fall is a variation value of the acceleration applied to the user in the vertical direction in a predetermined period of time. The index used for detecting impact is a scalar value of a composite vector of three axes acceleration detectable by an acceleration sensor provided to the user, in a predetermined period of time. The index used for detecting lying immobile is a period of time elapsed after the user has stopped moving with the inclination of the terminal device 20 being a value within a predetermined range due to the user assuming a predetermined posture (such as lying down, leaning on a desk, steering wheel, or the like, and hanging by a safety belt). In the present embodiment, the predetermined range is a range determined in advance as a range of possible inclination of the terminal device 20 when the user lies down. Note that the range may be adjusted to any range in accordance with designation of the user or the like. The index used for detecting fatigue is the duration of work. In the present embodiment, a plurality of reference values used for detecting fatigue are determined based on Wet Bulb Globe Temperature value (WBGT value). The index used for detecting high heart rate is the heart rate of the user. The indices are acquired and transmitted to the server device 10 by the terminal device 20. This process will be described below.

The sensitivity table 401 will be described with reference to FIG. 4.

The sensitivity table 401 indicates correspondence between an item (hereinafter, referred to as work item) of work performed by the user and the sensitivity of the detection for each abnormal situation. The sensitivity of detection is a measure indicating a chance of detecting the abnormal situation as the detection target. Higher sensitivity indicates a higher chance of detection. In the present embodiment, the sensitivity of the detection is any of a plurality ranked values (four values of “normal”, “slightly low”, “low”, and “OFF” in the descending order in the present embodiment). Of “normal”, “slightly low”, “low”, and “OFF” indicating the sensitivity level, “normal” indicates the highest sensitivity, “slightly low” indicates the second highest sensitivity, and “low” indicates the third highest sensitivity, and “OFF” indicates the lowest sensitivity. The sensitivity “OFF” indicates that the detection is not performed.

In the present embodiment, the server device 10 detects the abnormal situation of the user with the terminal device 20, based on the sensitivity corresponding to the work item of the work performed by the user stored in the sensitivity table 401. When detecting the abnormal situation, the server device 10 corrects the value of the reference value used for determining the abnormal situation by multiplying the value by a coefficient corresponding to the detection sensitivity if the detection sensitivity is any of “slightly low” or “low”, and detects the abnormal situation when the value of the index used for determining the abnormal situation is equal to or more than the reference value after the correction. The coefficient is a value larger than 1, and the value increases as the corresponding sensitivity decreases. For example, the coefficient 1.2 and 1.5 are assumed to be set for “slightly low” and “low”, respectively. With this setting, when the value (sensor value) of the index with which the abnormal situation is determined with the detection sensitivity “normal” is detected, the abnormal situation is not determined with “low” since the reference value is not exceeded, whereby abnormality can be prevented from being determined excessively. In the present embodiment, a low detection sensitivity indicates that the reference value is high, and a high detection sensitivity indicates that the reference value is low.

As described above, the server device 10 detects the abnormal situation of the user based on a determination criterion corresponding to the work item of the work performed by the user. The determination criterion is a criterion indicating how the abnormal situation is detected, and in the present embodiment, is a criterion indicating what kind of reference value is to be exceed by what kind of index value for the abnormal situation to be detected.

In the present embodiment, the detection sensitivity is determined in advance, in such a manner that a predetermined threshold (such as “slightly low” or “low” for example) would not be exceeded by the detection sensitivity for an abnormal situation determined in advance as an abnormal situation that is expected to involve erroneous detection during work.

For example, the user is almost completely free of risk of falling with work items not included in work with a risk of falling such as work at a high place (work at a position at a height equal to or higher than a predetermined height (such as 5 m for example) from the ground), work involving climbing up and down using a stepladder or the like (agricultural work such as harvest work and weeding work), and work on a mountain slope (such as agricultural work). Therefore, fall detected with such work items is expected to be erroneous detection. Thus, in the present embodiment, the sensitivity for detecting fall for such work items is set to be equal to or lower than a predetermined value (“low” in the present embodiment). In the example illustrated in FIG. 4, the sensitivity for detecting fall is determined to be equal to or lower than “low” for work expected to involve erroneous detection of fall such as a work during which a toxic gas can be generated (toxic gas zone work), an office work, crane operation work, work involving moving using a vehicle, and work using a hammer (hammer work).

The erroneous detection of abnormal situation is expected to occur in a case where a situation that may be confused with the abnormal situation during work is likely to occur. Thus, in the present embodiment, the detection sensitivity is determined in advance, in such a manner that a predetermined threshold (such as “slightly low” or “low” for example) would not be exceeded by the detection sensitivity for such an abnormal situation.

With work such as the work using a hammer, the work using agricultural tools, and the work involving movement using a vehicle, acceleration is applied to the user when the hammer or agricultural tool is used, the vehicle starts or stops, or the like. This acceleration may be confused with an impact applied to the user. Thus, impact is expected to be erroneously detected. Thus, in the present embodiment, for work items that may involve a situation where acceleration of a predetermined level or more is applied to the user such as the work using a hammer/agricultural tool, and the work involving movement using a vehicle, the sensitivity for detecting impact is set to be equal to or lower than a predetermined threshold. In the example illustrated in FIG. 4, the sensitivity for detecting impact is set to be “low” or lower, for the work involving movement using a vehicle, the hammer work, the harvest work, and the weeding work.

In the present embodiment, the detection sensitivity is determined in advance, in such a manner that the detection sensitivity for an abnormal situation determined in advance as an abnormal situation that is expected to lead to serious damage to the user during work is set to be equal to or higher than a predetermined threshold (such as “low” or “normal” for example). Fall tends to cause serious damage to the user, and thus a failure of the detection of such is desirably prevented as much as possible. In the example illustrated in FIG. 4, the detection sensitivity is set to be “normal” or higher for the work items involving a risk of fall, such as work at a high place, work involving climbing up and down using a stepladder or the like, and work on a mountain slope.

The processor 101 updates the sensitivity table 401 based on an operation performed by the user on an input device of the server device 10 in such a manner that the detection sensitivity for each abnormal situation changes each time an instruction to change the detection sensitivity for each abnormal situation for each work item is received. The processor 101 may receive an instruction to change the content of the sensitivity table 401 from the terminal device 20.

By using the sensitivity table 401 thus updated, the server device 10 can detect the abnormal situation based on the determination criterion expected by the user.

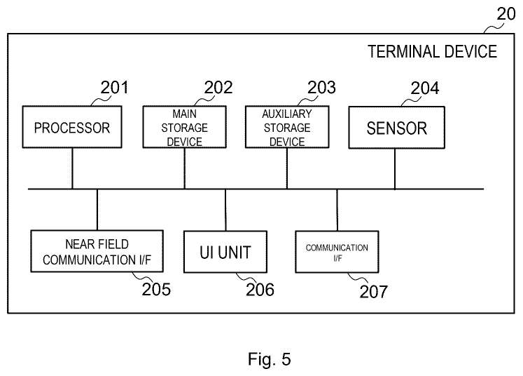

FIG. 5 is a diagram illustrating an example of a hardware configuration of each terminal device 20.

The terminal device 20 includes a processor 201, a main storage device 202, an auxiliary storage device 203, a sensor 204, a near field communication I/F 205, a UI unit 206, and a communication I/F 207.

The processor 201 is a control device that controls the terminal device 20. The main storage device 202 is a storage device such as a RAM used for temporarily storing information, loading a program, and the like. The auxiliary storage device 203 is a storage device such as HDD or SSD storing various types of information and various programs. The sensor 204 is a sensor that detects predetermined information. In the present embodiment, the sensor 204 is an acceleration sensor that detects the acceleration in three-axis directions orthogonal to each other, an inclination sensor that detects the inclination of the terminal device 20, a camera, a heart rate sensor that detects the heart rate of the user, a position sensor that detects a position by receiving a GNSS signal, and an altimeter. The near field communication I/F 205 is an interface used for near-field wireless communication with an environment sensor (sensor for detecting wet-bulb temperature, black-bulb temperature, dry-bulb temperature, and the like) provided in an environment where the user performs the work, a beacon that transmits a signal indicating position information, and the like. Hereinafter, the signal indicating the position information transmitted by the beacon is referred to as a beacon signal. The processor 201 acquires a wet-bulb temperature, a black-bulb temperature, and a dry-bulb temperature in an environment in which the user performs the work from the environment sensor via the near field communication I/F 205. The UI unit 206 includes an input unit such as a touch panel, a hard button, or a microphone used for input of information from the user, and an output unit such as a monitor or a speaker used to present information to the user. The communication I/F 207 is an interface used for communication with an external device such as the server device 10 via the network 30.

In the present embodiment, the terminal device 20 includes a heart rate sensor and detects a heart rate of the user, but in other examples, the terminal device 20 may acquire the heart rate of the user using other methods. For example, the processor 201 of the terminal device 20 may acquire, via the near field communication I/F 205, the heart rate of the user detected by an external device (such as a smartwatch for example) including the heart rate sensor, from the external device.

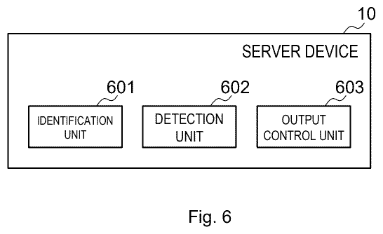

The functional configuration of the server device 10 will be described with reference to FIG. 6.

The processor 101 of the server device 10 executes a program stored in the auxiliary storage device 103 or the like, to function as an identification unit 601, a detection unit 602, and an output control unit 603. Processing described below to be mainly executed by the identification unit 601, the detection unit 602, and the output control unit 603, is actually processing mainly executed by the processor 101.

The identification unit 601 identifies the work item of the work performed by the user with the terminal device 20. The detection unit 602 detects the abnormal situation of the user, based on the determination criterion corresponding to the work item identified by the identification unit 601 via at least one of the sensor 204 of the terminal device 20 and an external sensor (such as environment sensor). The output control unit 603 outputs warning information for the abnormal situation detected by the detection unit 602.

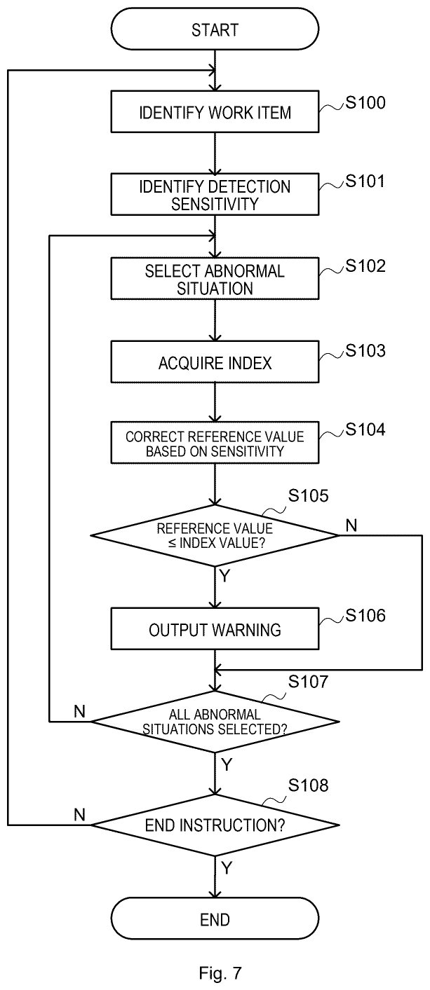

Detection processing for an abnormal situation of the user with the terminal device 20, executed by the server device 10, will be described with reference to FIG. 7. The processor 101 starts the processing in FIG. 7 upon receiving an instruction to start the detection processing for the abnormal situation of the user from the terminal device 20. Upon receiving the instruction to start the abnormal situation detection processing from the user via the UI unit 206, the processor 201 of the terminal device 20 transmits the instruction to start the abnormal situation detection processing to the server device 10. After transmitting the instruction to start the abnormal situation detection processing, the processor 201 periodically detects, via the sensor 204, the acceleration applied to the terminal device 20 (user), the inclination of the terminal device 20, and the heart rate of the user, and transmits these pieces of information thus detected to the server device 10. Note that the processor 201 may instruct the sensor 204 to transmit the value of the detected signal, only when a designated threshold is exceeded. In such a case, the sensor 204 transmits the detected signal to the processor 201 when a signal exceeding the designated threshold is detected. After transmitting the instruction to start the abnormal situation detection processing, the processor 201 periodically acquires a signal detected from the environment sensor provided in the environment in which the user performs the work or the beacon, via the near field communication I/F 205. The processor 201 periodically transmits the signal acquired from the environment sensor or the beacon to the server device 10.

In step S100, the identification unit 601 identifies the work item of the work performed by the user with the terminal device 20. In the present embodiment, the identification unit 601 identifies the work item of the work performed by the user based on the position (user position) of the terminal device 20. More specifically, the identification unit 601 inquires the terminal device 20 about the position of the terminal device 20. In response to the inquiry, the processor 201 of the terminal device 20 identifies the position (latitude, longitude, altitude) of the terminal device 20 via the position sensor and the altimeter included in the sensor 204. However, the processor 201 may identify the position of the terminal device 20 using another method. For example, when the periphery of the terminal device 20 includes a device transmitting the beacon signal indicating information of the position where the terminal device 20 exists, the processor 201 may receive the beacon signal and identify the position from the beacon signal thus received. The processor 201 transmits the identified position to the server device 10. The identification unit 601 acquires the work item corresponding to the position transmitted from the terminal device 20, based on the information indicating the correspondence between the position stored in advance in the auxiliary storage device 103 and the work item, and identifies the acquired work item as the work item of the work performed by the user.

When the processing in step S100 is completed, the identification unit 601 advances the processing to step S101. The processing in step S100 is an example of identification step.

In step S101, the detection unit 602 identifies the detection sensitivity for each abnormal situation corresponding to the work item identified in step S100, using the sensitivity table 401 stored in the auxiliary storage device 103. When the processing in step S101 is completed, the identification unit 601 advances the processing to step S102.

In step S102, the detection unit 602 selects one of a plurality of detection target abnormal situations (tumble, fall, impact, lying immobile, fatigue, and high heart rate). In the following description, the abnormal situation selected in immediately preceding step S102 is referred to as the selected abnormal situation. When the processing in step S102 is completed, the identification unit 601 advances the processing to step S103. When the detection sensitivity for the selected abnormal situation identified in step S101 is “OFF”, the detection unit 602 advances the processing to step S107, upon completing the processing in step S102.

In step S103, the detection unit 602 identifies the index corresponding to the selected abnormal situation, in the reference value table 301. The detection unit 602 acquires the value of the index identified. More specifically, the detection unit 602 functions as follows. When the selected abnormal situation is tumble, the detection unit 602 acquires the variation value of the acceleration in the vertical direction and the horizontal direction applied to the terminal device 20 within a predetermined period of time as the index value, based on the information of the acceleration applied to the terminal device 20 received from the terminal device 20.

When the selected abnormal situation is fall, the detection unit 602 acquires the converted value of the acceleration in the vertical direction applied to the terminal device 20 within a predetermined period of time as the index value, based on the information of the acceleration applied to the terminal device 20 received from the terminal device 20.

When the selected abnormal situation is impact, the detection unit 602 acquires, as the index value, the scalar value of the composite vector of the three-axes acceleration applied to the terminal device 20, based on the information of the acceleration applied to the terminal device 20 received from the terminal device 20.

When the selected abnormal situation is lying immobile, the detection unit 602 acquires the following value based on information of the inclination of the terminal device 20 and the acceleration applied to the terminal device 20, received from the terminal device 20. Specifically, the detection unit 602 acquires, as the index value, a period during which the inclination of the terminal device 20 is within a predetermined range corresponding to the work item of the work performed by the user and the acceleration applied to the terminal device 20 is zero.

When the selected abnormal situation is fatigue, the detection unit 602 acquires as the index value, the duration of the work by the user with the terminal device 20 (period elapsed after the abnormal situation detection processing has started). The detection unit 602 requests the terminal device 20 for the wet-bulb temperature/the black-bulb temperature/dry-bulb temperature of the environment in which the user performs the work. In response to the request, the processor 201 acquires the wet-bulb temperature/the black-bulb temperature/dry-bulb temperature from the environment sensor, and transmits the temperature to the server device 10, via the near field communication I/F 205. The detection unit 602 obtains a WBGT value based on the wet-bulb temperature/the black-bulb temperature/dry-bulb temperature received.

When the selected abnormal situation is high heart rate, the detection unit 602 acquires as the index value, the heart rate of the user received from the terminal device 20.

When the processing in step S103 is completed, the identification unit 601 advances the processing to step S104.

In step S104, the detection unit 602 acquires the reference value corresponding to the selected abnormal situation, from the reference value table 301. When the selected abnormal situation is fatigue, the detection unit 602 acquires the reference value corresponding to the WBGT value identified in step S103, from the reference value table 301. The detection unit 602 corrects the reference value acquired, based on the detection sensitivity for the selected abnormal situation identified in step S101. When the selected abnormal situation is tumble, the detection unit 602 corrects each of the two reference values.

More specifically, the detection unit 602 does not correct the reference value when the sensitivity for the selected abnormal situation is “normal”. The detection unit 602 performs the correction by multiplying the reference value by a predetermined coefficient larger than 1, when the sensitivity for the selected abnormal situation is “slightly low”. The detection unit 602 performs the correction by multiplying the reference value by a predetermined coefficient larger than that corresponding to “slightly low”, when the sensitivity for the selected abnormal situation is “low”. The coefficients respectively corresponding to the sensitivities “slightly low” and “low” may be different or the same among the detection target abnormal situations. When the processing in step S104 is completed, the identification unit 601 advances the processing to step S105.

In step S105, the detection unit 602 determines whether the index value acquired in the immediately preceding step S103 is equal to or more than the reference value correct based on the sensitivity in the immediately preceding step S104.

When the selected abnormal situation is tumble, the detection unit 602 determines that the index value is equal to or more than the reference value, when both of the two index values (the variation value of the acceleration of the vertical direction and the variation value of the acceleration in the horizontal direction) are equal to or more than the corresponding reference value.

Upon determining that the index value is equal to or more than the reference value, the detection unit 602 detects the selected abnormal situation and advances the processing to step S106. Upon determining that the index value is less than the reference value, the detection unit 602 determines that the selected abnormal situation is not occurring and advances the processing to step S107. The processing in step S105 is an example of detection step.

In step S106, the output control unit 603 outputs, to a predetermined output destination, information indicating warning for the occurrence of the selected abnormal situation. In the present embodiment, the output control unit 603 transmits the information indicating the warning for the selected abnormal situation to an information processing device of an administrator that manages the user, and makes a display unit of the information processing device display this information. Examples of the information indicating the warning for the abnormal situation include information indicating that the abnormal situation has occurred, information prompting countermeasure for the abnormal situation occurring, and the like.

Note that in the present embodiment, the output control unit 603 transmits alert information indicating the possibility of fall to the terminal device 20, and makes the UI unit 206 display the information to present the alert for the fall to the user, when the work item identified in step S100 is “harvest work”. This is because when the harvest is at a high place, the user may lose attention to his or her feet.

When the processing in step S106 is completed, the output control unit 603 advances the processing to step S107.

In step S107, the detection unit 602 determines whether all of the plurality of detection target abnormal situations have been selected as the selected abnormal situation in step S102. Upon determining that all of the plurality of detection target abnormal situations have been selected as the selected abnormal situation in step S102, the detection unit 602 advances the processing to step S108. Upon determining that there is an abnormal situation yet to be selected in step S102 as the selected abnormal situation in the plurality of detection target abnormal situations, the detection unit 602 advances the processing to step S102.

In step S108, the detection unit 602 determines whether an instruction to end the abnormal situation detection processing has been received from the terminal device 20. The detection unit 602 ends the processing in FIG. 7 upon determining that the instruction to end the abnormal situation detection processing has been received from the terminal device 20. Upon determining that the instruction to end the abnormal situation detection processing has not been received from the terminal device 20, the detection unit 602 clears the history of selection of the plurality of detection target abnormal situations as the selected abnormal situation, and advances the processing to step S100.

With the configuration of the present embodiment described above, the server device 10 detects the abnormal situation based on the determination criterion corresponding to the work item of the work performed by the user, and thus can contribute to improvement in the accuracy of the detection for the abnormal situation.

In the present embodiment, regarding the work item performed by the user, the server device 10 sets the detection sensitivity to be a predetermined value or lower, for the abnormal situation determined in advance as the abnormal situation expected to involve erroneous detection. Thus, the server device 10 can reduce the erroneous detection of the abnormal situation.

For the work item of the work performed by the user, the server device 10 sets the detection sensitivity to be equal to or higher than the predetermined value, for the abnormal situation determined in advance to be the abnormal situation leading to a serious damage to the user. Thus, the server device 10 can reduce the failure to detect the abnormal situation.

### Second Embodiment

In the present embodiment, the server device 10 detects the abnormal situation, based on a determination criterion corresponding a load of the work performed by the user (hereinafter, referred to as work load), instead of the work item of the work performed by the user.

The detection system 1 of the present embodiment will be described below based on a difference from the first embodiment.

The system configuration of the detection system 1 of the present embodiment is the same as that in the first embodiment. The hardware configurations of the server device 10 and the terminal device 20 of the present embodiment are the same as those in the first embodiment.

The functional configuration of the server device 10 of the present embodiment will be described.

As in the first embodiment, the processor 101 of the present embodiment functions as the identification unit 601, the detection unit 602, and the output control unit 603.

The identification unit 601 of the present embodiment identifies the work load of the work performed by the user with the terminal device 20. The detection unit 602 detects the abnormal situation of the user, based on the determination criterion corresponding to the work load identified by the identification unit 601 via at least one of the sensor 204 of the terminal device 20 and an external sensor (such as environment sensor). The output control unit 603 is the same as that in the first embodiment.

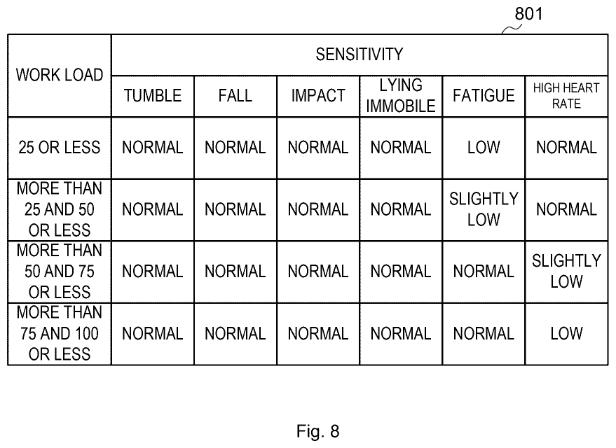

In the present embodiment, the server device 10 uses a sensitivity table 801 instead of the sensitivity table 401. The sensitivity table 801 is stored in advance in the auxiliary storage device 103. The sensitivity table 801 of the present embodiment will be described with reference to FIG. 8.

The sensitivity table 801 of the present embodiment indicates the correspondence between the work load and the detection sensitivity of each abnormal situation.

The work load is a measure a larger value of which indicating a larger load of the work. In the present embodiment, the value is equal to or more than 0 and equal to or less than 100.

In the present embodiment, the value of the work load is ranked into four ranks: a rank of 25 or less, a rank of more than 25 and 50 or less, a rank of more than 50 and 75 or less, and a rank or more than 75 and 100 or less.

In the present embodiment, the detection sensitivity is set to be equal to or lower than a threshold, for an abnormal situation determined in advance as an abnormal situation expected to involve erroneous detection, regarding the value of the work load.

For the value of the work load of the rank of 25 or less and the rank of more than 25 and 50 or less, the detection sensitivity for fatigue is set to be “slightly low” or lower. This is because the fatigue is expected to be less accumulated with a work involving a smaller load.

In the present embodiment, the detection sensitivity is set to be equal to or higher than the threshold, for an abnormal situation determined in advance as an abnormal situation leading to serious damage to the user, regarding the value of the work load.

For the value of the work load of the rank of 25 or less and the rank of more than 25 and 50 or less, the detection sensitivity for high heart rate is set to be “normal” or higher. This is because the work with a smaller load involves a smaller factor increasing the heart rate, meaning that an increase in the heart rate under such a situation is likely to be attributable to heart abnormality. Still, for avoiding the risk of high heart rate under a large work load, the high heart rate detection sensitivity may be set to be higher for a larger work load.

Thus, the detection unit 602 can change the detection sensitivity for “fatigue” and “high heart rate” depending on the work load value. In the present embodiment, the detection unit 602 sets a higher detection sensitivity for “fatigue” and “high heart rate” for a larger work load value.

Also for the abnormal situations other than “fatigue” and “high heart rate”, the detection unit 602 may change the detection sensitivity in accordance with the work load value. The detection unit 602 may set the detection sensitivity to be equal to or higher than the predetermined threshold, also for the abnormal situations (such as tumble, fall, impact, and lying immobile, for example) other than “fatigue” and “high heart rate”, when the period during which the value of the work load is equal to or more than the predetermined threshold continues to be equal to or longer than a predetermined period threshold, because such a situation leads to a high risk of occurrence of industrial accident due to deterioration in physical strength and judgment of the worker. For example, the detection unit 602 may set the detection sensitivity to be normal, for a situation the detection sensitivity for which is lower than normal among tumble, fall, impact, and lying immobile.

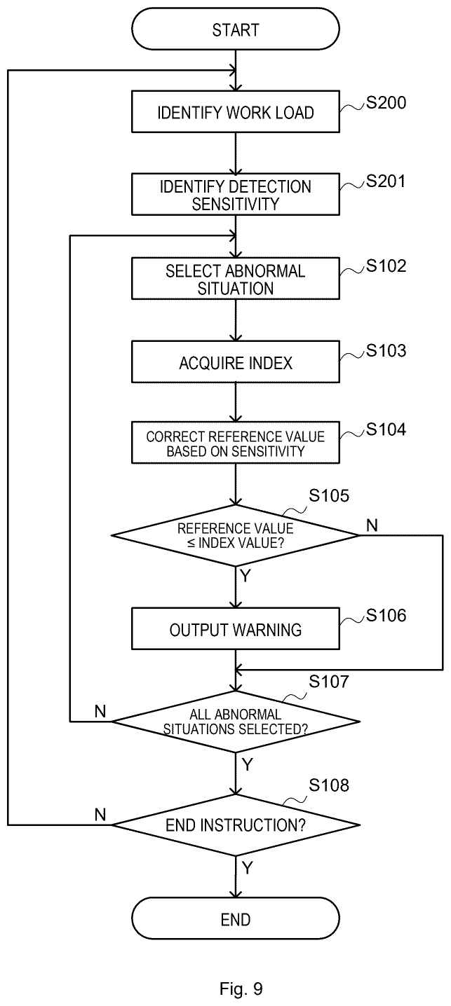

Abnormal situation detection processing of the present embodiment will be described with reference to FIG. 9. The processing in FIG. 9 will be described below based on a difference from the processing in FIG. 7.

The processing in FIG. 9 is different from the processing in FIG. 7 in that processing in step S200 and step S201 is included instead of the processing in step S100 and step S101.

In step S200, the identification unit 601 identifies the work load of the work performed by the user, based on the heart rate of the user within an immediately preceding predetermined period of time acquired from the terminal device 20. When the predetermined period of time includes a break period of the user, the identification unit 601 identifies the work load based on the heart rate of the user in a period after the break period. In the present embodiment, the identification unit 601 obtains an average heart rate of the user for each certain interval (such as an interval of a predetermined seconds for example) within a predetermined period of time (or the period after the break period). The identification unit 601 determines whether the average heart rate in each interval is equal to or higher than a predetermined threshold. The identification unit 601 identifies the work load by multiplying the number of intervals in which the average heart rate is equal to or higher than the predetermined threshold by a predetermined coefficient.

When the processing in step S200 is completed, the identification unit 601 advances the processing to step S201.

In step S201, the detection unit 602 identifies the detection sensitivity for each abnormal situation corresponding to the work load identified in step S200, using the sensitivity table 801 indicating the correspondence between the work load and the abnormal situation detection sensitivity.

With the configuration of the present embodiment described above, the server device 10 detects the abnormal situation based on the determination criterion corresponding to the work load of the work performed by the user, and thus can contribute to improvement in the accuracy of the detection for the abnormal situation.

In the present embodiment, for the work load of the work performed by the user, the server device 10 sets the detection sensitivity to be a predetermined value or lower, for the abnormal situation determined in advance as the abnormal situation expected to involve erroneous detection. Thus, the server device 10 can reduce the erroneous detection of the abnormal situation.

For the work load of the work performed by the user, the server device 10 sets the detection sensitivity to be equal to or higher than the predetermined value, for the abnormal situation determined in advance to be the abnormal situation leading to serious damage to the user. Thus, the server device 10 can reduce the failure to detect the abnormal situation.

### Third Embodiment

In the present embodiment, the server device 10 detects the abnormal situation, based on a determination criterion corresponding the work item of the work performed by the user and the work load of the work performed by the user.

The detection system 1 of the present embodiment will be described below based on a difference from the first embodiment.

The system configuration of the detection system 1 of the present embodiment is the same as that in the first embodiment. The hardware configurations of the server device 10 and the terminal device 20 of the present embodiment are the same as those in the first embodiment.

The functional configuration of the server device 10 of the present embodiment will be described.

As in the first embodiment, the processor 101 of the present embodiment functions as the identification unit 601, the detection unit 602, and the output control unit 603.

The identification unit 601 of the present embodiment identifies the work item and the work load of the work performed by the user with the terminal device 20. The detection unit 602 detects the abnormal situation of the user based on the determination criterion corresponding to the work item and the work load identified by the identification unit 601. The output control unit 603 is the same as that in the first embodiment.

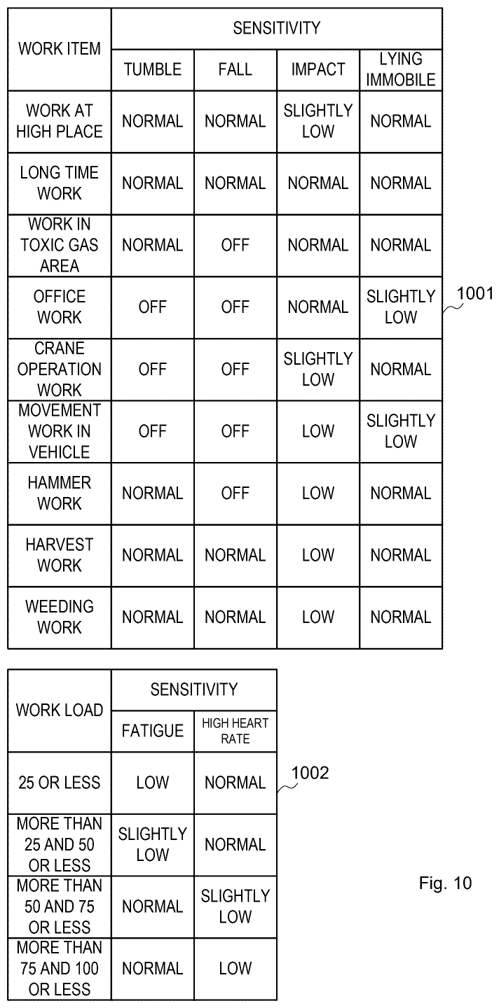

In the present embodiment, the server device 10 uses sensitivity tables 1001 and 1002 instead of the sensitivity table 401. The sensitivity tables 1001 and 1002 are stored in advance in the auxiliary storage device 103. The sensitivity tables 1001 and 1002 of the present embodiment will be described with reference to FIG. 10.

The sensitivity table 1001 of the present embodiment is a table indicating the correspondence between the work item and the detection sensitivity for tumble/fall/impact/lying immobile. The sensitivity table 1002 is a table indicating the correspondence between the work load and the detection sensitivity for fatigue/high heart rate.

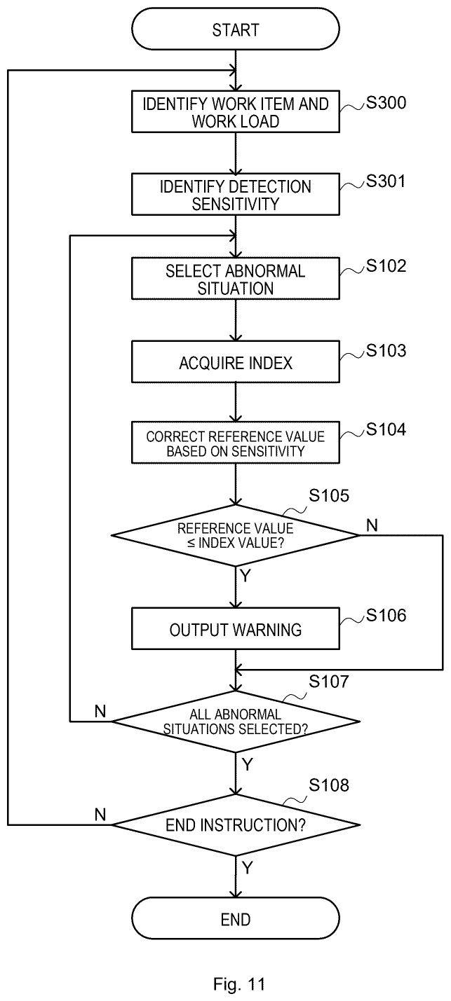

Abnormal situation detection processing of the present embodiment will be described with reference to FIG. 11. The processing in FIG. 11 will be described below based on a difference from the processing in FIG. 7.

The processing in FIG. 11 is different from the processing in FIG. 7 in that processing in step S300 and step S301 is included instead of the processing in step S100 and step S101.

In step S300, the identification unit 601 identifies the work item of the work performed by the user through the processing as in the first embodiment. Furthermore, the identification unit 601 identifies the work load of the work performed by the user through the processing as in the second embodiment.

In step S301, the detection unit 602 identifies the detection sensitivity for each abnormal situation corresponding to the work item and the work load identified in step S100, using the sensitivity tables 1001 and 1002.

With the configuration of the present embodiment described above, the server device 10 detects the abnormal situation based on the determination criterion corresponding to the work item and the work load of the work performed by the user, and thus can contribute to improvement in the accuracy of the detection for the abnormal situation.

### Fourth Embodiment

In the present embodiment, the server device 10 detects the abnormal situation based on a determination criterion corresponding to a movement type of the user.

The detection system 1 of the present embodiment will be described below based on a difference from the first embodiment.

The system configuration of the detection system 1 of the present embodiment is the same as that in the first embodiment. The hardware configurations of the server device 10 and the terminal device 20 of the present embodiment are the same as those in the first embodiment. In the present embodiment, the detection target abnormal situations include a moving body inclination, in addition to tumble, fall, impact, lying immobile, fatigue, and high heart rate. Moving body inclination is an abnormal situation under which a moving body (such as bicycle, automobile, forklift, or heavy machinery) used by the user is inclined by a certain amount or more and may tumble. In the present embodiment, the moving body that may be used by the user includes an inclination sensor, an acceleration sensor, and an internal camera.

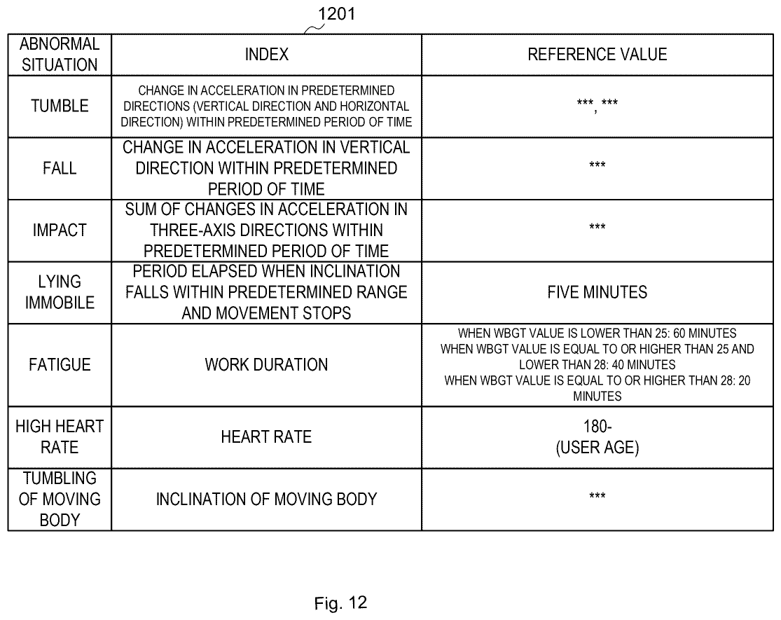

In the present embodiment, the server device 10 uses a reference value table 1201 instead of the reference value table 301. The reference value table 1201 is stored in advance in the auxiliary storage device 103. The reference value table 1201 of the present embodiment will be described with reference to FIG. 12.

In the example illustrated in FIG. 12, the reference value table 1201 includes information of an index and a reference value for the abnormal situation: vehicle tumbling, in addition to the various types of information in the example illustrated in FIG. 3. The index used for detecting moving body inclination is inclination of the moving body detected by the inclination sensor provided to the moving body.

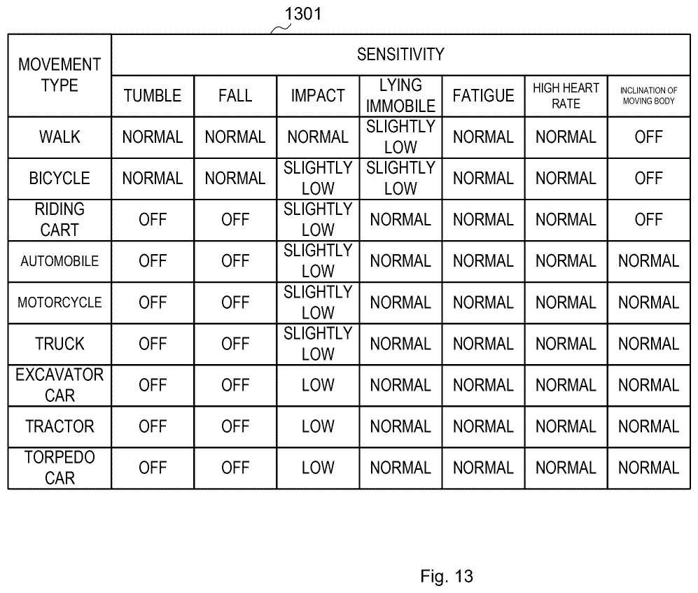

In the present embodiment, the server device 10 uses a sensitivity table 1301 instead of the sensitivity table 401. The sensitivity table 1301 is stored in advance in the auxiliary storage device 103. The sensitivity table 1301 of the present embodiment will be described with reference to FIG. 13. The sensitivity table 1301 of the present embodiment indicates the correspondence between a possible movement type of the user and the detection sensitivity for each abnormal situation. In the present embodiment, the possible movement type of the user includes walk, bicycle, riding cart, automobile, motorcycle, truck, excavator, tractor, and torpedo car, but as another example, some of these may not be included, or other movement types such as a forklift may be included.

In the present embodiment, the detection sensitivity is determined in advance, in such a manner that a predetermined threshold (such as “slightly low” or “low” for example) would not be exceeded by the detection sensitivity for an abnormal situation determined in advance as an abnormal situation that is expected to involve occurrence of erroneous detection during work.

For example, when the movement type of the user is not walk or bicycle, the user is not expected to tumble or fall. Thus, tumble or fall detected with the movement type of the user not being walk or bicycle, is expected to be erroneous detection. Thus, in the present embodiment, the detection sensitivity for tumble and fall with the movement type other than walk or bicycle is set to be a predetermined value (“low” in the present embodiment) or lower. In the example illustrated in FIG. 13, for the riding cart, automobile, motorcycle, truck, excavator, tractor, and torpedo car with which erroneous detection of tumble or fall is not expected to occur, the detection sensitivity for tumble and fall is set to be “low” or lower.

The erroneous detection of abnormal situation is expected to occur in a case where a situation that may be confused with the abnormal situation during work is likely to occur. Thus, in the present embodiment, the detection sensitivity is determined in advance, in such a manner that a predetermined threshold (such as “slightly low” or “low” for example) would not be exceeded by the detection sensitivity for such an abnormal situation.

The user riding some kind of moving body receives acceleration at the time of starting, stopping, and the like. This acceleration may be confused with an impact applied to the user. Thus, impact is expected to be erroneously detected. Thus, in the present embodiment, the detection sensitivity for impact is set to be a predetermined threshold or lower, for the movement type other than walk. In the example illustrated in FIG. 13, regarding the bicycle, riding cart, automobile, motorcycle, truck, excavator, tractor, and torpedo car, the detection sensitivity for impact is set to be “slightly low” or lower.

In the present embodiment, the detection sensitivity is determined in advance, in such a manner that the detection sensitivity for an abnormal situation determined in advance as an abnormal situation that is expected to involve serious damage to the user during work is set to be equal to or higher than a predetermined threshold. When the state of the user riding a moving body such as an automobile becomes lying immobile, the moving body may make an unexpected movement leading to an accident expected to lead to serious damage to the user. Thus, when the user is riding such a moving body, it is desired to prevent a failure to detect lying immobile as much as possible. In the example illustrated in FIG. 13, regarding the riding cart, automobile, motorcycle, truck, excavator, tractor, and torpedo car, the detection sensitivity for lying immobile is set to be “normal” or higher.

The functional configuration of the server device 10 of the present embodiment will be described.

As in the first embodiment, the processor 101 of the present embodiment functions as the identification unit 601, the detection unit 602, and the output control unit 603.

The identification unit 601 of the present embodiment identifies the movement type of the user with the terminal device 20. The detection unit 602 detects the abnormal situation of the user based on the determination criterion corresponding to the work load identified by the identification unit 601 via at least one of the sensor 204 and an external sensor. The output control unit 603 is the same as that in the first embodiment.

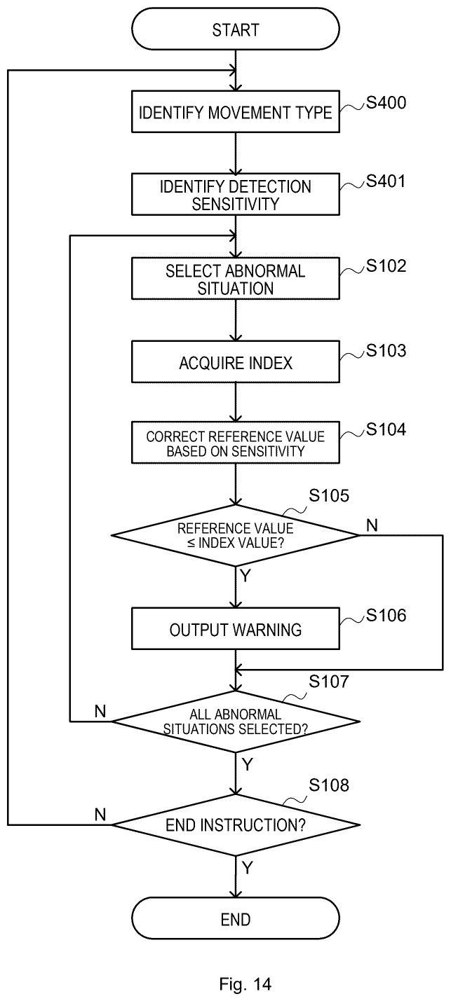

Abnormal situation detection processing of the present embodiment will be described with reference to FIG. 14. The processing in FIG. 14 will be described below based on a difference from the processing in FIG. 7. The processing in FIG. 14 is different from the processing in FIG. 7 in that processing in step S400 and step S401 is included instead of the processing in step S100 and step S101.

In step S400, the identification unit 601 identifies the movement type of the user. In the present embodiment, in a case where communication (bidirectional communication or unidirectional communication) is performed between the terminal device 20 of the user and the communication device provided to the moving body, the identification unit 601 identifies the moving body as the movement type of the user. More specifically, the identification unit 601 functions as follows.

In the present embodiment, each of the moving bodies that may be ridden by the user includes a communication device that emits a predetermined beacon signal receivable in the vicinity of the moving body. Upon receiving the beacon signal from the communication device of the moving body via the near field communication I/F 205, the processor 201 of the terminal device 20 transmits the received beacon signal to the server device 10. Upon receiving the beacon signal, based on the received beacon signal, the identification unit 601 identifies the moving body including the communication device that has emitted the beacon signal, and identifies the identified moving body as the movement type of the user. When no beacon signal is received, the identification unit 601 identifies walk as the movement type of the user.

Upon identifying a predetermined moving body as the movement type of the user, the identification unit 601 periodically acquires information of the inclination and acceleration detected by the inclination sensor and the acceleration sensor in the identified moving body and an image captured by the internal camera of the moving body.

When the processing in step S400 is completed, the identification unit 601 advances the processing to step S401.

In step S401, the detection unit 602 identifies the detection sensitivity for each abnormal situation corresponding to the movement type identified in immediately preceding step S400, using the sensitivity table 1301.

Note that, in step S103 of the present embodiment, in a case where the movement type of the user is a predetermined moving body, the detection unit 602 acquires a value of an index for the abnormal situation: impact (scalar value of composite vector of three-axes acceleration detectable by the acceleration sensor) based on a value of acceleration detected via the acceleration sensor of the moving body. However, even if the movement type of the user is a predetermined moving body, the detection unit 602 may acquire the value of the index for the abnormal situation: impact based on the value of the acceleration detected by the acceleration sensor of the terminal device 20.

Furthermore, in the present embodiment, in a case where the movement type of the user is a predetermined moving body, the detection unit 602 detects an abnormal situation based on a signal detected by a sensor of the moving body. In the present embodiment, in step S103, the detection unit 602 acquires the value of the index for the abnormal situation: moving body inclination based on the inclination value detected by the inclination sensor, and detects moving body inclination based on the acquired value.

When the movement type of the user is a predetermined moving body, in step S103, the detection unit 602 acquires the value of the index for an abnormal situation: lying immobile as follows. The detection unit 602 acquires the following value based on images sequentially captured in time series by the internal camera of the moving body. Specifically, the detection unit 602 acquires a period in which the user is not moving while assuming a posture (such as, for example, a posture without holding the steering wheel or a posture of leaning on the steering wheel) different from a predetermined driving posture (posture of holding the steering wheel and looking forward). The detection unit 602 detects lying immobile using the value of the period acquired.

In step S106 of the present embodiment, when the movement type is a predetermined moving body and the selected abnormal situation is impact, the output control unit 603 outputs information indicating a warning for sudden braking as a warning for the impact.

Furthermore, in the present embodiment, the detection unit 602 detects dangerous driving of the user based on an image captured by the internal camera of the moving body. When the user continues to assume a posture different from a predetermined driving posture for a predetermined period (such as three seconds or five seconds for example), the detection unit 602 outputs information indicating a warning for dangerous driving to a predetermined output destination (such as, for example, the terminal device 20, the display unit of the moving body, the server device 10, or the information processing device of the administrator). The detection unit 602 stores the image indicating the state of dangerous driving in the auxiliary storage device 103. Thus, the server device 10 can contribute to analysis of the situation during the dangerous driving.

With the configuration of the present embodiment described above, the server device 10 detects the abnormal situation based on the determination criterion corresponding to the movement type of the user, so as to be capable of detecting the abnormal situation in accordance with situations where the user is using different movement types, and thus can contribute to improvement in the accuracy of the detection for the abnormal situation.

In the present embodiment, the server device 10 sets the detection sensitivity to be equal to or lower than a predetermined value, for an abnormal situation determined in advance for a movement type of the user as an abnormal situation expected to involve erroneous detection. Thus, the server device 10 can reduce the erroneous detection of the abnormal situation.

The server device 10 sets the detection sensitivity to be equal to or higher than a predetermined value for an abnormal situation determined in advance for a movement type of the user as an abnormal situation leading to serious damage to the user. Thus, the server device 10 can reduce the failure to detect the abnormal situation.

In the present embodiment, when the movement type is a predetermined moving body, the detection unit 602 acquires the value of the index for lying immobile, based on the image captured by the internal camera of the moving body. With the image, a period in which the user is not moving can be more accurately obtained. As a result, the detection unit 602 can more accurately detect the user lying immobile.

### Supplement

In the embodiments described above, the server device 10 detects tumble, fall, impact, lying immobile, fatigue, and high heart rate as the abnormal situation. The server device 10 may not detect at least some of these abnormal situations, and may detect other abnormal situations (such as gas leakage, an excessive drop in heart rate, and heavy stress). For example, the sensor 204 may include a gas sensor that detects gas. In this case, the processor 201 of the terminal device 20 detects the gas concentration. The processor 101 acquires the gas concentration from the terminal device 20 via the gas sensor, and detects gas leakage when the concentration acquired is equal to or higher than a reference value. For example, the processor 201 of the terminal device 20 may acquire, via the near field communication I/F 205, the gas concentration detected by an external device (such as a gas detector for example) including a gas sensor, from the external device, and transmit the acquired gas concentration to the server device 10.

For example, the processor 101 may detect heavy stress when the heart rate of the user is equal to or higher than a reference value.

In the embodiments described above, the server device 10 uses, as an index used for detecting an abnormal situation, an index a larger value of which indicating a higher level of the abnormal situation. Alternatively, the server device 10 may use, as the index used for detecting abnormal situation, an index a smaller value of which indicating a higher level of abnormal situation (such as, for example, the reciprocal of the index in the embodiments described above, or a heart rate for detecting an abnormal situation with an excessive drop in heart rate including cardiopulmonary arrest and the like). In this case, the detection unit 602 may correct the reference value in accordance with the sensitivity, that is, to be smaller for a lower sensitivity in step S104. Then, the detection unit 602 may detect the abnormal situation when the value of the index is equal to or less than the reference value in step S105. Thus, the server device 10 can detect an abnormal situation in accordance with the sensitivity, also by using the index a smaller value of which indicating a higher level of the abnormal situation.

In the embodiments described above, the duration of work by the user with the terminal device 20 is used as the index for detecting the abnormal situation: fatigue. Alternatively, other indices may be used as the index for detecting the abnormal situation: fatigue. For example, a stress value of the user may be used as the index for detecting the abnormal situation: fatigue. This stress value is an index a higher value of which indicating heavier stress expected to be felt. It has been found that heavier stress felt leads to the sympathetic nerve being more activated.

Thus, for example, in step S103, the detection unit 602 may estimate the level of activation of the sympathetic nerve based on the heart rate detected by the heart rate sensor of the sensor 204, and acquire the level as the stress value. Specifically, the detection unit 602 first measures the power spectral density in order to extract the periodic structure from the time-series data of the heart rate variability. The power spectral density includes a high-frequency fluctuation component (HF component) and a low-frequency component (LF component). The detection unit 602 obtains the sums of the intensities in the LF component region (from 0.05 Hz to 0.15 Hz) and in the HF component region (from 0.15 Hz to 0.40 Hz) as the value of the LF component and the value of the HF component, respectively. Then, detection unit 602 may obtain (the value of the LF component)/(the value of the HF component) as the stress value.

In a relaxed state, that is, when the parasympathetic nerve is activated, an HF component reflecting respiratory fluctuation and an LF component reflecting blood pressure fluctuation appear. On the other hand, in a stressed state, that is, when the sympathetic nerve is activated, the LF component appears while the HF component decreases. Thus, a larger stress value indicates heavier stress.

In the embodiments described above and in the present embodiment, the sensor 204 is an acceleration sensor that detects the acceleration in three-axis directions, an inclination sensor that detects the inclination of the terminal device 20, a camera, a heart rate sensor that detects the heart rate of the user, a position sensor that detects a position by receiving a GNSS signal, and an altimeter. However, the sensor 204 may not include at least some of these. For example, the sensor 204 may not include an altimeter. In this case, the processor 101 may acquire altitude information from an altimeter provided in an environment in which the user performs work.

In the embodiments described above, the server device 10 sets the detection sensitivity to be equal to or lower than a predetermined threshold for an abnormal situation that is expected to involve erroneous detection and is determined in advance for any of the work item and the work load of the work performed by the user and the movement type of the user. Alternatively, the server device 10 may set, for an abnormal situation that is expected to involve erroneous detection and is determined in advance for any of the work item and the work load of the work performed by the user and the movement type of the user, the detection sensitivity as follows. Specifically, the server device 10 may make the detection sensitivity for the abnormal situation lower than that in a case where erroneous detection is not expected to occur under the abnormal situation. For example, the server device 10 may set the detection sensitivity for fall to be lower for the work item: office work the detection of fall during which is expected to be erroneous, than that for the work item: work at high place the detection of fall during which is expected to be not erroneous.

In the embodiments described above, the output control unit 603 outputs warning information for the detected abnormal situation. The output control unit 603 may switch the display mode of the warning information according to the degree of severity of the detected abnormal situation. For example, the output control unit 603 may acquire a value of a difference obtained by subtracting the reference value from the value of the index corresponding to the abnormal situation as a measure indicating the severity of the abnormal situation, and switch the display mode of the warning information according to the acquired measure. For example, the output control unit 603 may switch the content of the warning information output according to whether the acquired measure is equal to or more than the threshold value. For example, when the acquired measure is equal to or more than the threshold, the output control unit 603 may output information indicating that the situation is more serious than that in a case where the acquired measure is lower than the threshold. When the acquired measure is equal to or more than the threshold, the output control unit 603 may display warning information in a color different from that in a case where the measure is lower than the threshold. When the acquired measure is equal to or more than the threshold, the output control unit 603 may output as the warning information, a sound different from that in a case where the measure is lower than the threshold. The output control unit 603 may receive a response indicating that a warning has been confirmed from an output destination of the information indicating the warning. When this response is not received within a predetermined period from the output of the information indicating the warning, the output control unit 603 may notify a predetermined output destination (such as police station or fire department) of the information indicating the warning for the abnormal situation. Thus, the server device 10 can improve the safety of the user.

In the embodiments described above, the output control unit 603 outputs the information indicating a warning for an abnormal situation to the information processing device of the administrator. Alternatively, the output control unit 603 may output the information indicating a warning for an abnormal situation to another output destination. For example, the output control unit 603 may output this information to the terminal device 20 of other users present within a predetermined range from the user under the abnormal situation. Furthermore, the output control unit 603 may output this information to the terminal device 20 of the user under the abnormal situation. For example, the output control unit 603 may transmit information (such as, for example, information indicating that it is recommended to take a break in a case where the abnormal situation is fatigue) indicating a warning for occurrence of the selected abnormal situation to the terminal device 20 of the user, and cause the UI unit 206 to display this information.

The output control unit 603 may change the output destination of the information indicating the warning according to the type of the abnormal situation detected by the detection unit 602. The output control unit 603 may output the warning information to the terminal device 20 of the user when the abnormal situation detected by the detection unit 602 is fatigue, and may output the warning information to the terminal device 20 of another user in the periphery of the user, the information processing device of the administrator, or the like when the abnormal situation detected by the detection unit 602 is fall. Thus, the server device 10 can present the warning for each abnormal situation, for the person involved in the abnormal situation occurred.

In the embodiments described above, the output control unit 603 outputs the information indicating a warning for an abnormal situation by making the display unit display the information. Alternatively, the output control unit 603 may output the information indicating a warning for an abnormal situation with different forms. For example, the output control unit 603 may output the information indicating a warning for an abnormal situation, in a form of sound using a speaker. Furthermore, the output control unit 603 may output the information indicating a warning for an abnormal situation by making a vibrator or the like vibrate, or by emitting light from a lamp such as a rotating lamp.

In the embodiments described above, the server device 10 detects an abnormal situation of the user based on a determination criterion corresponding to one of: at least one of the work item and the work load of the work performed by the user; and the movement type of the user. Alternatively, the server device 10 may detect an abnormal situation of the user based on a determination criterion corresponding to both of: at least one of the work item and the work load of the work performed by the user; and the movement type of the user.

For example, the detection unit 602 may function as follows. Specifically, the detection unit 602 obtains the detection sensitivity for each abnormal situation as in the third embodiment, and identifies the movement type of the user as in the fourth embodiment. Then, when the movement type identified is walk or bicycle, the detection unit 602 may not update the detection sensitivity for each abnormal situation, and may update the detection sensitivity for a predetermined abnormal situation (such as tumble or fall for example) to be equal to or lower than a predetermined threshold when the movement type identified is a vehicle or a work vehicle. Furthermore, once in every predetermined period of time, the detection unit 602 may identify the movement type of the user, and update the detection sensitivity for an abnormal situation depending on the movement type identified.

For example, the detection unit 602 may function as follows. The detection unit 602 obtains the detection sensitivity for each abnormal situation as in the fourth embodiment. Then, the detection unit 602 obtains the work load of the work performed by the user as in the second embodiment. When the work load obtained is equal to or more than the predetermined threshold, the detection unit 602 may increase the detection sensitivity for each of the abnormal situations obtained.

In the first and the third embodiments described above, the identification unit 601 identifies the work item based on the position of the user. Alternatively, the identification unit 601 may identify the work item of the work performed by the user with the terminal device 20 using other methods.

For example, the identification unit 601 acquires an image (such as, for example, the image of the user or the image of the environment around the user) of the periphery of the terminal device 20 captured by the camera of the terminal device 20. The identification unit 601 requests the terminal device 20 for the image of the periphery of the terminal device 20, to acquire the image of the periphery of the terminal device 20. In response to the request, the processor 201 of the terminal device 20 captures the image of the periphery of the terminal device 20 using the camera of the sensor 204, and transmits the captured image to the server device 10. Note that the identification unit 601 may acquire the image of the periphery of the terminal device 20 captured by a camera different from the camera of the terminal device 20. For example, the identification unit 601 may acquire an image captured by another camera (such as a helmet-mounted camera or a body camera) provided to the user with the terminal device 20, an image captured by a fixed camera or the like provided around the user, or the like.

The identification unit 601 may identify the work item based on the acquired image. For example, when recognizing a tool (such as agricultural tools, instruments, equipment, or vehicles) used for the work of the specific work item from the image, the identification unit 601 may identify the work item of the work using the recognized tool as the work item of the work performed by the user.

Furthermore, for example, the identification unit 601 may acquire information of a type different from the position of the user (such as, for example, information of a timing when the work is performed), and identify the work item of the work of the user from information indicating correspondence between the information of the type and the work item. For example, if the work item of the work performed by the user is determined based on timings (such as, for example, weeding work in summer, and harvest work in autumn), the identification unit 601 may identify the work item based on the timing when the work is performed.

For example, when a schedule for work is determined for each user, the identification unit 601 may function as follows. Specifically, the identification unit 601 may acquire the identification information of the user from the terminal device 20, identify the schedule of the user corresponding to the acquired identification information, and identify the work item of the work performed by the user at the time of the processing.

For example, the identification unit 601 may inquire the terminal device 20 about the work item of the work performed by the user. In response to the inquiry, the processor 201 inquires the user about the work item via the UI unit 206. Upon receiving an input (such as touch input, voice input, and gesture input) of the work item from the user via the UI unit 206, the processor 201 transmits the input work item to the server device 10. The identification unit 601 may identify the work item received from the terminal device 20 as the work item of the work performed by the user.

For example, upon reading information on a code (such as a two-dimensional code, barcode, a chameleon code, and a color bit) attached to a tool used for the work via the camera of the sensor 204, the processor 201 of the terminal device 20 may transmit the information of the code thus read to the server device 10. The identification unit 601 may identify the work item of the work performed by the user based on the information of the code. For example, the identification unit 601 may identify the work item of the work using the tool corresponding to the code.

For example, upon performing communication with a near-field communication device (such as RFID chip or NFC card) attached to a tool used for the work via the communication I/F 207, the processor 201 of the terminal device 20 may transmit the information on the tool with the near-field communication device with which the communication has been performed, to the server device 10. The identification unit 601 may identify the work item of the work performed by the user based on the information on the tool. For example, the identification unit 601 may identify the work item of the work performed using the tool.

In the second and the third embodiments described above, the identification unit 601 identifies the work load of the work performed by the user based on the heart rate of the user. Alternatively, the identification unit 601 can identify the work load of the work performed by the user, through other methods.

For example, the identification unit 601 identifies the work item of the work performed by the user. Here, it is assumed that the information indicating correspondence between the work item and the work load of the work within a certain period is stored in advance in the auxiliary storage device 103. The identification unit 601 may identify as the work load of the work performed by the user, a value obtained by multiplying the work load within a certain period corresponding to the work item identified from the correspondence information by the period during which the user continues to perform the work.

In addition, for example, it is assumed that information indicating the correspondence between information of a predetermined type (for example, the position of the work, timing, user identification information, and the like) and a work load is stored in advance in the auxiliary storage device 103. In this case, the identification unit 601 may acquire the information of the predetermined type from the terminal device 20, and acquire the work load corresponding to the acquired information as the work load of the work performed by the user from the correspondence information.

Furthermore, for example, it is assumed that a schedule of the user is determined in advance, and a work load of each work is also determined in advance. The identification unit 601 may identify the work load of the work performed by the user based on these pieces of information.

In addition, the identification unit 601 may correct the work load based on weather information (such as temperature, humidity, illuminance, WBGT value, UV index, and wind speed), environmental information (such as gas concentration, radioactivity, and photochemical oxidant concentration), or the like. For example, if the WBGT value is equal to or higher than a predetermined value, the identification unit 601 may correct the work load by multiplying the work load by a predetermined coefficient larger than 1. For example, if the temperature is equal to or lower than a predetermined value, the identification unit 601 may correct the work load by multiplying the work load by a predetermined coefficient smaller than 1.

For example, the identification unit 601 may receive designation of a value of the work load of the work performed by the user. For example, the identification unit 601 may receive the value of the work load input by the user on the terminal device 20 from the terminal device 20.

In the fourth embodiment described above, the moving body is provided with the communication device that emits the beacon signal, and when the terminal device 20 receives the beacon signal, the identification unit 601 identifies as the movement type of the user, the moving body including the communication device that has emitted the beacon signal. Alternatively, the identification unit 601 may identify the movement type of the user, through other methods.

For example, each moving body may be provided with a communication device different from the communication device that emits the beacon signal. For example, each moving body may be provided with a communication device such as an RFID tag or an NFC card. In this case, upon receiving predetermined information from these communication devices of the moving body via the near field communication I/F 207, the processor 201 of the terminal device 20 transmits the received information to the server device 10. Upon receiving the information, based on the received information, the identification unit 601 may identify the moving body including the communication device that has transmitted the information, and identify the identified moving body as the movement type of the user.

For example, upon reading information on a code (such as a two-dimensional code, barcode, a chameleon code, and a color bit) attached to the moving body via the camera of the sensor 204, the processor 201 of the terminal device 20 may transmit the information on the code thus read to the server device 10. Based on the information of the code, the identification unit 601 may identify the moving body to which the code is attached, and identify the identified moving body as the movement type of the user.

For example, the identification unit 601 may identify the movement type of the user based on an image of the periphery of the terminal device 20 captured by the camera of the terminal device 20, a camera of the user, a fixed external camera, the internal camera of the moving body, and the like. Upon recognizing at least a part (such as, for example, external appearance, internal equipment (such as seat and steering wheel)) of the moving body in the image in the periphery of the terminal device 20, the identification unit 601 may identify the moving body as the movement type of the user.

For example, the identification unit 601 may identify the movement type of the user based on a sound in the periphery of the terminal device 20. For example, when the identification unit 601 recognizes a predetermined sound (such as engine sound), generated as a result of a movement of the moving body, in the environmental sound around the terminal device 20 recorded by a microphone of the terminal device 20, this moving body may be identified as the movement type of the user.

For example, the identification unit 601 may identify the movement type of the user based on a speed of the user. For example, the identification unit 601 may obtain the speed of the terminal device 20 from the time-series change in the position information of the terminal device 20, and identify the movement type of the user as a predetermined moving body (for example, an automobile or a motorcycle) in a case where the obtained speed is equal to or higher than a predetermined threshold (such as, for example, 30 km/h).

The above-described device, program, and method may be implemented with a single device or may be implemented using components common to a plurality of devices, and thus include various aspects. Furthermore, variations can be made as appropriate to implement a configuration partially constituted by software and partially constituted by hardware and the like. The invention is also implementable with a recording medium for a program controlling a device. It is a matter of course that the recording medium for the program may be a magnetic recording medium or a semiconductor memory, and the above concept is directly applicable to any recording medium to be developed in the future.

### Reference Signs List

1 Detection system
10 Server device
20 Terminal device
30 Network
101 Processor
102 Main storage device
103 Auxiliary storage device
104 Communication I/F
201 Processor
202 Main storage device
203 Auxiliary storage device
204 Sensor
205 Near field communication I/F
206 UI unit
207 Communication I/F
301 Reference value table
401 Sensitivity table
801 Sensitivity table
1001 Sensitivity table
1002 Sensitivity table
1201 Reference value table
1301 Sensitivity table

1. An information processing device comprising:
an identification unit configured to identify a movement type of a user; and
a detection unit configured to detect an abnormal situation of the user using a determination criterion based on the movement type identified by the identification unit via a sensor provided to the user or provided in periphery of the user.

2. The information processing device according to claim 1, wherein the detection unit detects the abnormal situation based on the determination criterion with a sensitivity for detecting the abnormal situation, which is determined in advance for the movement type and expected to involve occurrence of erroneous detection, being equal to or lower than a threshold.

3. The information processing device according to claim 1, wherein the detection unit detects the abnormal situation based on the determination criterion with a sensitivity for detecting the abnormal situation, which is determined in advance for the movement type identified by the identification unit and expected to involve occurrence of erroneous detection, being lower than a case where the occurrence of erroneous detection is not expected.

4. The information processing device according to claim 1, wherein the detection unit detects the abnormal situation based on the determination criterion with a sensitivity for detecting the abnormal situation, which is determined in advance for the movement type identified by the identification unit and expected to involve serious damage to the user, being equal to or higher than a threshold.

5. The information processing device according to claim 1, wherein when communication is performed between a device provided to the user and a device provided to a moving body, the identification unit identifies the moving body as the movement type.

6. The information processing device according to claim 1, wherein when the movement type identified by the identification unit is a predetermined moving body, the detection unit detects the abnormal situation via a sensor provided to the moving body.

7. The information processing device according to claim 1, further comprising an output control unit configured to output information of a warning to a predetermined output destination corresponding to the abnormal situation detected by the detection unit.

8. The information processing device according to claim 7, wherein the output control unit outputs the information of the warning to the output destination corresponding to a type of the abnormal situation detected by the detection unit.

9. An information processing method executed by an information processing device, the information processing method comprising:
an identification step of identifying a movement type of a user; and
a detection step of detecting an abnormal situation of the user using a determination criterion based on the movement type identified in the identification step via a sensor provided to the user or provided in periphery of the user.

10. A program causing a computer to perform:
an identification step of identifying a movement type of a user, and
a detection step of detecting an abnormal situation of the user using a determination criterion based on the movement type identified in the identification step via a sensor provided to the user or provided in periphery of the user.
